(19) United States
(12) Patent Application Publication
(10) Pub. No.: US 2012/0243608 A1
(43) Pub. Date: Sep. 27, 2012

(54) VIDEO CODING AND DECODING METHOD, AND CODING AND DECODING APPARATUS

(75) Inventors: Lu Yu, Shenzhen (CN); Binbin Yu, Shenzhen (CN); Shangwen Li, Shenzhen (CN); Dong Wang, Beijing (CN); Mingyuan Yang, Beijing (CN); Lianhuan Xiong, Shenzhen (CN)

(73) Assignee: Huawei Technologies Co., Ltd., Shenzhen (CN)

(21) Appl. No.: 13/492,498

(22) Filed: Jun. 8, 2012

Related U.S. Application Data
(63) Continuation of application No. PCT/CN2010/079117, filed on Nov. 25, 2010.

(30) Foreign Application Priority Data
Dec. 9, 2009 (CN) 200910251282.1

(51) Int. Cl. H04N 7/32

(52) U.S. Cl. 375/240.12; 375/E07.243

(57) ABSTRACT

The present invention relates to a video coding and decoding method, and coding and decoding apparatus. The coding method includes: generating a second order prediction flag for a coding block; when the coding block needs second order prediction, generating a second order prediction flag for at least one sub-block of the coding block, where the second order prediction flag of the sub-block is used to indicate whether second order prediction is performed on the sub-block; performing prediction according to the second order prediction flag of the coding block and the second order prediction flag of the at least one sub-block of the coding block to obtain a prediction image; and obtaining a prediction residual according to the prediction image, and coding the prediction residual.

### CROSS-REFERENCE TO RELATED APPLICATIONS

This application is a continuation of International Application No. PCT/CN2010/079117, filed on Nov. 25, 2010, which claims priority to Chinese Patent Application No. 200910251282.1, filed on Dec. 9, 2009, both of which are hereby incorporated by reference in their entireties.

### TECHNICAL FIELD

The present invention relates to the field of video coding and decoding technologies, and in particular, to a video coding and decoding method, and coding and decoding apparatus.

### BACKGROUND

A large amount of redundant information exists in video signals. Such redundant information may be divided into spatial redundant information, time redundant information, data redundant information, and visually redundant information.

Video compression technologies are generally based on a conventional hybrid coding (Hybrid Coding) framework integrating block-directed coding, prediction coding, transform coding, and entropy coding.

According to the conventional hybrid coding framework, in prediction coding, a coding frame is divided into coding units, prediction coding is performed on the coding units to obtain a prediction value, a difference, i.e., residual data, between the prediction value and a value to be coded is calculated, and two-dimensional transform coding is performed on the residual data; the transform coefficient is quantized and scanned in the transform domain, and then converted into a one-dimension signal, and finally entropy coding is performed.

In the prior art, a coding and decoding method of using second order prediction is proposed. According to the method, the prediction in the conventional hybrid coding framework is defined as the first order prediction, and the process of image reconstruction using the decoding technology includes a second order prediction and compensation process and second order prediction storage; correspondingly, the prediction residual in the conventional hybrid coding framework is defined as the first order residual, and the prediction for the first order residual is defined as the second order prediction. The second order prediction and compensation process includes the first order prediction and compensation process and the second order prediction and compensation process. In the second order prediction and compensation process, the first order residual after reconstruction and the second order residual after reconstruction are input to obtain the residual after reconstruction.

The coding method includes the second order prediction process and the second order prediction storage. The second order prediction process includes the first order prediction process and the second order prediction process. In the second order prediction process, the first order residual and the prediction value of the first order residual are input to obtain the second order residual. The prediction value of the first order residual is generated from the first order residual after reconstruction using the prediction method in second order mode. A corresponding bit stream generated by using the coding method includes the first order mode and the second order residual, with the first order residual excluded; or includes the first order mode, the second order mode, and the second order residual, with the first order residual excluded.

During implementation of the present invention, the inventor finds that the prior art has at least the following disadvantage: second order prediction is directed to a macroblock, which to be specific is, for a macroblock, either all its sub-blocks use second order prediction or none of its sub-blocks use second order prediction, and consequently, second order prediction lacks flexibility and the coding efficiency is low.

### SUMMARY

Embodiments of the present invention provide a video coding and decoding method, and coding and decoding apparatus, refining the unit of the coding and decoding block identified by the second order prediction flag for second order prediction, so as to enhance flexibility of second order prediction, and improve the coding and decoding efficiency.

An embodiment of the present invention provides a video coding method, including:

generating a second order prediction flag for a coding block;

when the coding block needs second order prediction, generating a second order prediction flag for at least one sub-block of the coding block, where the second order prediction flag of the sub-block is used to indicate whether second order prediction is performed for the sub-block;

performing prediction according to the second order prediction flag of the coding block and the second order prediction flag of the at least one sub-block of the coding block to obtain a prediction image; and

obtaining a prediction residual according to the prediction image, and coding the prediction residual.

An embodiment of the present invention provides a video coding apparatus, including:

a first generating module, configured to generate a second order prediction flag for a coding block;

a second generating module, configured to generate a second order prediction flag for at least one sub-block of the coding block when the coding block needs second order prediction, where the second order prediction flag of the sub-block is used to indicate whether second order prediction is performed on the sub-block; and

a predicating module, configured to perform prediction according to the second order prediction flag of the coding block and the second order prediction flag of the at least one sub-block of the coding block to obtain a prediction image.

According to the video coding method and coding apparatus provided in the embodiments of the present invention, the unit identified by the second order prediction flag for second order prediction is refined to a sub-block level in a way of identifying the sub-block of the coding block by using the second order prediction flag of the sub-block, i.e., the unit of the coding block identified by the second order prediction flag for second order prediction is refined, which may enhance the flexibility of second order prediction and improve the coding and decoding efficiency.

An embodiment of the present invention provides a video decoding method, including:

obtaining a second order prediction flag of a decoding block;

obtaining a second order prediction flag of at least one sub-block of the decoding block when the second order prediction flag of the decoding block indicates that the decoding block needs second order prediction; and

performing prediction according to the second order prediction flag of the decoding block and the second order prediction flag of the at least one sub-block of the decoding block to obtain a prediction image;

An embodiment of the present invention provides a video decoding apparatus, including:

a first obtaining module, configured to obtain a second order prediction flag of a decoding block;

a second obtaining module, configured to obtain a second order prediction flag of at least one sub-block of the decoding block when the second order prediction flag of the decoding block indicates that the decoding block needs second order prediction; and

a decoding predicating module, configured to perform prediction according to the second order prediction flag of the decoding block and the second order prediction flag of the at least one sub-block of the decoding block to obtain a prediction image.

According to the video decoding method and decoding apparatus provided in the embodiments of the present invention, the unit for second order prediction is refined to the sub-block level by obtaining the second order prediction flag of the sub-block identifying the first-level sub-block of the decoding block, i.e., the unit of the decoding block identified by the second order prediction flag for second order prediction is refined, which may enhance the flexibility of second order prediction and improve the decoding efficiency.

### BRIEF DESCRIPTION OF THE DRAWINGS

To make the technical solution of the embodiments of the present invention clearer, the accompanying drawings for illustrating the embodiments of the present invention are briefly described below. Apparently, the accompanying drawings illustrate some exemplary embodiments of the present invention, and persons skilled in the art may derive other drawings from such accompanying drawings without creative efforts.

FIG. 1 is a flowchart of a video coding method according to a first embodiment of the present invention;

FIG. 2 is a flowchart of a video decoding method according to a second embodiment of the present invention;

FIG. 3 is a flowchart of a video coding method according to a third embodiment of the present invention;

FIG. 4 is a schematic diagram of the structure of a macroblock according to the third embodiment, a fourth embodiment, a fifth embodiment, and a sixth embodiment of the present invention;

FIG. 5 is a flowchart of a video decoding method according to the fourth embodiment of the present invention;

FIG. 6 is a flowchart of a video coding method according to the fifth embodiment of the present invention;

FIG. 7 is a flowchart of a video decoding method according to the sixth embodiment of the present invention;

FIG. 8 is a flowchart of a video coding method according to a seventh embodiment of the present invention;

FIG. 9 is a schematic diagram of the structure of a macroblock according to the seventh embodiment and an eighth embodiment of the present invention;

FIG. 10 is a flowchart of a video decoding method according to the eighth embodiment of the present invention;

FIG. 11 is a schematic diagram of a CABAC process in a video coding method according to an embodiment of the present invention;

FIG. 12 is a flowchart of arithmetic coding in CABAC in a video coding method according to an embodiment of the present invention;

FIG. 13 is a flowchart of a coding method for syntax element sub_sop_flag of an m×n sub-block in a video coding method according to an embodiment of the present invention;

FIG. 14 is a schematic diagram of a sub-block involved in a coding method for syntax element sub_sop_flag of an m×n sub-block in a video coding method according to an embodiment of the present invention;

FIG. 15 is a flowchart of a decoding method for syntax element sub_sop_flag of an m×n sub-block in the decoding method according to an embodiment of the present invention;

FIG. 16 is a schematic structural diagram of a video coding apparatus according to an embodiment of the present invention; and

FIG. 17 is a schematic structural diagram of a video decoding apparatus according to an embodiment of the present invention.

### DETAILED DESCRIPTION

The technical solution disclosed in embodiments of the present invention is hereinafter described clearly with reference to embodiments and accompanying drawings. Evidently, the embodiments are exemplary only, not covering all embodiments of the present invention. Persons skilled in the art may derive other embodiments from the embodiments given here without making creative efforts, and all such embodiments fall within the protection scope of the present invention.

When the second order prediction technology is used in coding and decoding, the following syntax elements may be added: second order prediction flag (Second Order Prediction Flag, sop_flag), prediction second prediction mode flag (Prediction Second Prediction Mode Flag, pred_sp_mode_flag), and remaining second prediction mode (Remaining Second Prediction Mode, rem_sp_mode).

sop_flag is a second order prediction flag used for identifying whether the second order prediction technology is used in the current coding or decoding block. The value of sop_flag is 0 or 1. To be specific, for a coding or decoding block, sop_flag in a bit stream indicates whether all sub-blocks in the coding or decoding block use second order prediction or none of the sub-blocks use second order prediction. When the value of sop_flag of the macroblock is 0, it indicates that none of the sub-blocks of the coding or decoding block use second order prediction for reconstruction. In this case, syntax elements pred_sp_mode_flag and rem_sp_mode do not need to be generated at the coding end, and syntax elements pred_sp_mode_flag and rem_sp_mode do not need to be parsed from the bit stream at the decoding end. When the value of sop_flag of the coding or decoding block is 1, it indicates that all sub-blocks of the coding or decoding block use second order prediction for reconstruction. In this case, syntax elements pred_sp_mode_flag and rem_sp_mode are generated at the coding end and written into a bit stream after being entropy coded, and syntax elements pred_sp_mode_flag and rem_sp_mode are parsed from the bit stream at the decoding end.

pred_sp_mode_flag and rem_sp_mode are syntax elements related to the second order intra-frame prediction mode. The value of the second order intra-frame prediction mode ranges from 0 to 8, representing nine intra-frame prediction modes respectively. The decoding method in second order intra-frame prediction mode is the same as that in 4×4 intra-frame prediction mode defined in H.264/AVC, that is, to check whether the prediction is accurate. If the prediction is accurate, the mode corresponding to the mode prediction value is used; if the prediction is not accurate, information needs to be continuously parsed from the bit stream to obtain the mode.

pred_sp_mode flag indicates whether the prediction in second order intra-frame prediction mode is accurate. The value of pred_sp_mode_flag is 0 or 1. rem_sp_mode is the information used to indicate the second order intra-frame prediction mode when the prediction in second order intra-frame prediction mode is not accurate. If the prediction in current second order intra-frame prediction mode is accurate, the bit stream does not have syntax element rem_sp_mode in current second order intra-frame prediction mode. The value of rem_sp_mode ranges from 0 to 7.

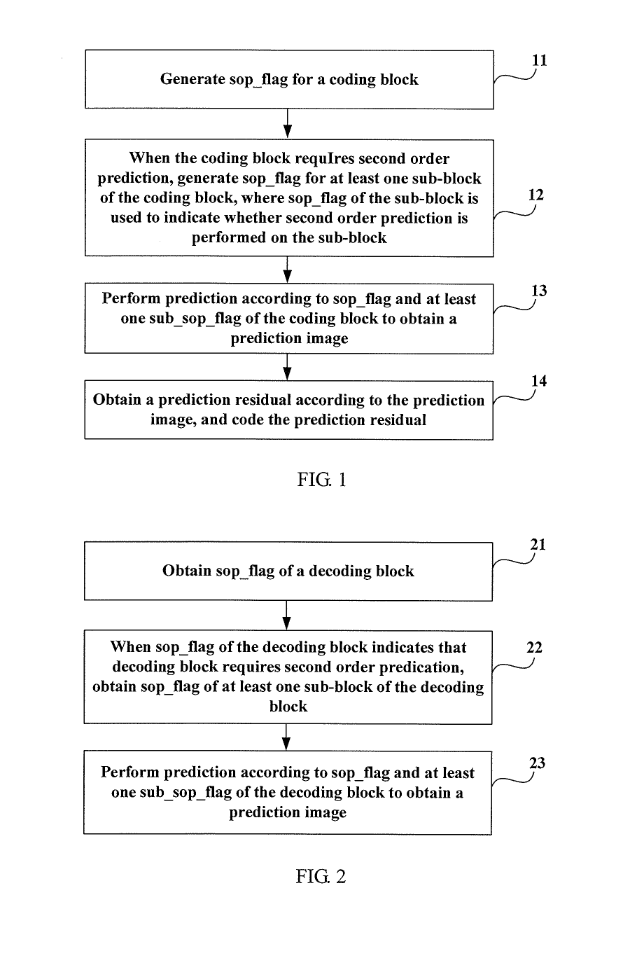

FIG. 1 is a flowchart of a video coding method according to a first embodiment of the present invention. The method includes the following steps:

Step 11: Generate sop_flag for a coding block.

For example, sop_flag is generated for the coding block according to a rule, or sop_flag is generated for the coding block adaptively. If sop_flag is generated adaptively, sop_flag does not need to be written into a bit stream after being entropy coded, and transmitted to the decoding end.

Step 12: When the coding block needs second order prediction, generate sop_flag for at least one sub-block of the coding block, where sop_flag of the sub-block is used to indicate whether second order prediction is performed on the sub-block.

When the coding block needs second order prediction, in the coding block corresponding to sop_flag, second order prediction is performed on at least one first-level sub-block. In this case, sop_flag is generated for each sub-block of the coding block. For ease of description, sop_flag of the sub-block is hereinafter referred to as a sub second order prediction flag (Sub Second Order Prediction Flag, sub_sop_flag), where the sub_sop_flag is used to indicate whether second order prediction is performed on a corresponding sub-block.

If the value of sop_flag is 0, it indicates that second order prediction is performed on none of the sub-blocks of a corresponding coding block; if the value of sop_flag is 1, it indicates that second order prediction is performed on at least one sub-block of the corresponding coding block.

When second order prediction is to be performed on at least one sub-block of the coding block, similarly to step 11, sub_sop_flag is generated for each sub-block of the coding block according to a rule or generated adaptively. If the value of sub_sop_flag is 0, it indicates that the corresponding sub-block does not use second order prediction for reconstruction; if the value of sub_sop_flag is 1, it indicates that the corresponding sub-block uses second order prediction for reconstruction.

When sub_sop_flag is generated adaptively, considering changes between images, adaptation generally causes inaccuracy of the information. Specifically, sub_sop_flag may be generated for the first frame in intra-frame coding according to a rule, and then transmitted to the decoding end. sub_sop_flag may be generated adaptively as follows: for subsequent frames, sub_sop_flag of the current sub-block is directly obtained according to the value of sub_sop_flag of the coded block of a reference frame corresponding to a motion vector, which enables flexible coding. In addition, a new syntax element is added in slice header information, indicating whether adaptation is used during current frame coding. If adaptation is used, sub_sop_flag of the current sub-block is directly obtained according to the value of sub_sop_flag of the decoded block of the reference frame corresponding to a motion vector; if adaptation is not used, sub_sop_flag is generated according to a rule. The method for obtaining sub_sop_flag adaptively is not limited thereto.

Step 13: Perform prediction according to sop_flag of the coding block and at least one sub_sop_flag of the coding block to obtain a prediction image.

Step 14: Obtain a prediction residual according to the prediction image, and code the prediction residual.

In this embodiment, corresponding pred_sp_mode_flag is generated for the sub-block of the coding block, on which second order prediction is performed.

For example, pre_sp_mode_flag is generated according to a rule for the sub-block on which second order prediction is performed. When the value of pred_sp_mode_flag is 0, rem_sp_mode also needs to be generated so that the decoding end performs, according to the generated rem_sp_mode, decoding and reconstruction using second order prediction.

Entropy coding is performed on pred_sp_mode_flag and then the coded pred_sp_mode_flag is written into a bit stream.

When the value of pred_sp_mode_flag is 1, only pred_sp_mode_flag needs to be entropy-coded and written into a bit stream, and then transmitted to the decoding end. The decoding end generates rem_sp_mode adaptively according to pre_sp_mode_flag. When the value of pred_sp_mode_flag is 0, rem_sp_mode also needs to be entropy-coded and written into a bit stream, and then transmitted to the decoding end. The decoding end performs, according to the received rem_sp_mode, decoding and reconstruction using second order prediction.

According to the technical solution in this embodiment, the unit identified by sop_flag for second order prediction is refined to the sub-block level in a way of identifying the sub-block of the coding block by using sub_sop_flag. To be specific, the size of the block on which second order prediction is performed is reduced or appropriately combined to bring advantages of the second order prediction technology into full play so that the coding efficiency when all of the sub-blocks of the current coding block do not use second order prediction is higher than that when all sub-blocks of the coding block use second order prediction, or higher than that when none of the sub-blocks of the coding block use second order prediction. According to the technical solution in this embodiment, the unit of the coding block identified by the second order prediction flag for second order prediction is refined to the sub-block level, i.e., the unit of the coding block identified by the second order prediction flag for second order prediction is refined, which may enhance the flexibility of second order prediction and improve the coding and decoding efficiency.

When sop_flag is generated according to a rule and needs to be transmitted to the decoding end, the video coding method according to the embodiment of the present invention may further include: performing entropy coding for sop_flag and sub_sop_flag and writing the coded sop_flag and sub_sop_flag into a bit stream.

When sop_flag and sub_sop_flag are generated adaptively and do not need to be transmitted to the decoding end, the video coding method according to the embodiment of the present invention may further include:

adding a syntax element, which is used to indicating whether adaptation is used during current frame coding, in slice header information of the bit stream.

When the sub-block of the coding block further includes multiple sub-blocks, for ease of description, the sub-blocks of the coding block are referred to as first-level sub-blocks, the sub-blocks of the first-level sub-block are referred to as second-level sub-blocks, the sub-blocks of the second-level sub-block are referred to as third-level sub-blocks, and so on. When the value of sub_sop_flag is 0, it indicates that second order prediction is performed for none of the second-level sub-blocks of the corresponding first-level sub-block; when the value of sub_sop_flag is 1, it indicates that second order prediction is performed for all second-level sub-blocks of the corresponding first-level sub-block. In this case, the generating corresponding pred_sp_mode_flag and rem_sp_mode for the first-level sub-block of the coding block, on which second order prediction is performed, may include:

in the first-level sub-block, on which second order prediction is performed, generating a second sub second order prediction flag (Second Sub Second Order Prediction Flag, second_sub_sop_flag) for each second-level sub-block, where second_sub_sop_flag is used to indicate whether second order prediction is performed for the corresponding second-level sub-block; and

generating corresponding pred_sp_mode_flag or further generating rem_sp_mode for the second-level sub-block on which second order prediction is performed.

second_sub_sop_flag may be generated adaptively or generated according to a rule.

When second_sub_sop_flag is generated adaptively, it does not need to be transmitted to the decoding end. The decoding end also generates second_sub_sop_flag adaptively.

When second_sub_sop_flag needs to be transmitted to the decoding end, the video coding method according to the embodiment of the present invention may further include: performing entropy coding on second_sub_sop_flag and then writing the coded second_sub_sop_flag into the bit stream.

When the size of the coding block is 64×64 or 128×128, and so on, the coding block may be divided into third-level sub-blocks, fourth-level sub-blocks, or even more refined sub-blocks. Similarly to the process of coding sub_sop_flag and second_sub_sop_flag, sop_flag may be refined to the third sub second order prediction flag (Third Sub Second Order Prediction Flag, Third_sub_sop_flag), or the fourth sub second order prediction flag (Fourth Sub Second Order Prediction Flag, Fourth_sub_sop_flag), and so on, to identify whether second order prediction is performed on a smaller unit, which further meets requirements for the flexibility of second order prediction and improves the coding efficiency.

Corresponding to the first embodiment, FIG. 2 is a flowchart of a video decoding method according to a second embodiment of the present invention. The method includes the following steps:

Step 21: Obtain sop_flag of a decoding block.

When a bit stream sent by a coding end is received and the bit stream includes sop_flag, sop_flag may be parsed from the bit stream; when the bit stream does not include sop_flag, a syntax element used to indicate whether adaptation is used during current frame coding may be parsed from slice header information of the bit stream. When adaptation is used during current frame coding, sop_flag may be obtained adaptively.

Step 22: When sop_flag of the decoding block indicates that the decoding block needs second order prediction, obtain sop_flag of at least one sub-block of the decoding block (at least one sub_sop_flag).

When the bit stream includes sub_sop_flag, sub_sop_flag may be parsed from the bit stream; when the bit stream does not include sub_sop_flag, a syntax element used to indicate whether adaptation is used during current frame coding may be parsed from slice header information of the bit stream. When adaptation is used during current frame coding, sub_sop_flag may be obtained adaptively. For example, sub_sop_flag of the current sub-block is directly obtained according to the value of sub_sop_flag of the decoded block of the reference frame corresponding to a motion vector. For details about sub_sop_flag, reference can be made to the description in step 12.

Step 23: Perform prediction according to sop_flag of the decoding block and at least one sub_sop_flag of the decoding block to obtain a prediction image.

In this embodiment, for the first-level sub-block of the decoding block, on which second order prediction is performed, the corresponding pre_sp_mode_flag of is parsed from the bit stream, and decoding and reconstruction using second order prediction are performed. When the value of pred_sp_mode_flag is 0, rem_sp_mode needs to be further parsed.

According to the technical solution in this embodiment, the unit for second order prediction is refined to the sub-block level by obtaining sub_sop_flag identifying the first-level sub-block of the decoding block. To be specific, the size of the block on which second order prediction is performed is reduced or appropriately combined so that advantages of the second order prediction technology are brought into full play, which meets the requirements for different coding efficiencies.

When the first-level sub-block is divided into multiple second-level sub-blocks, in step 24, that for the first-level sub-block of the decoding block, on which second order prediction is performed, the corresponding pred_sp_mode_flag is parsed from the bit stream includes:

obtaining second_sub_sop_flag of each second-level sub-block of the first-level sub-block on which second order prediction is performed, where the second_sub_sop_flag is used to indicate whether second order prediction is performed for the corresponding second-level sub-block; and

for the second-level sub-block on which second order prediction is performed, parsing the corresponding pred_sp_mode_flag from the bit stream.

When the size of the decoding block is 64×64 or 128×128, and so on, the coding block may be divided into third-level sub-blocks, fourth-level sub-blocks, or even more refined sub-blocks. Similarly to the process of decoding sub_sop_flag and second_sub_sop_flag, sop_flag may be refined to the third sub second order prediction flag (Third Sub Second Order Prediction Flag, Third_sub_sop_flag), or the fourth sub second order prediction flag (Fourth Sub Second Order Prediction Flag, Fourth_sub_sop_flag), and so on, to identify whether second order prediction is performed for a smaller unit, which further meets requirements for the flexibility of second order prediction.

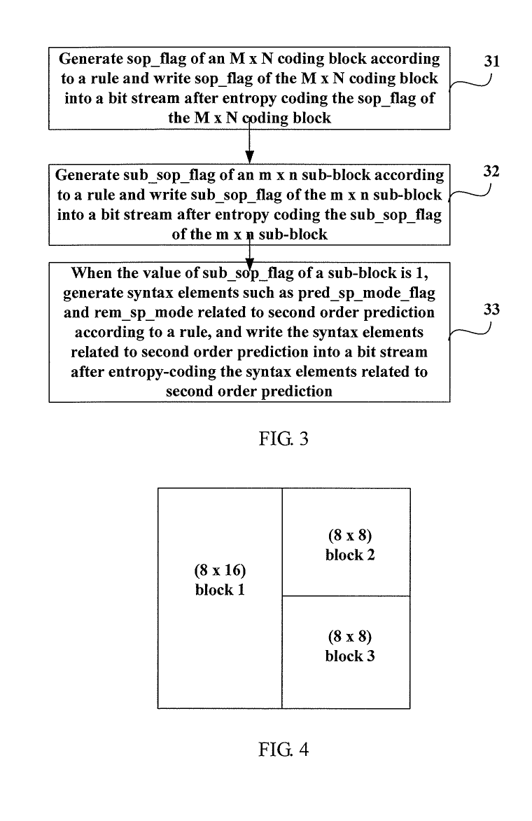

FIG. 3 is a flowchart of a video coding method according to a third embodiment of the present invention. The method includes the following steps:

Step 31: Generate M×N sop_flag, that is, sop_flag of a coding block of a size of M×N (hereinafter referred to as an M×N coding block) according to a rule, which may be but not limited to a rate distortion optimization (Rate Distortion Optimization, RDO) criterion, and write sop_flag of the M×N coding block into a bit stream after entropy coding the sop_flag of the M×N coding block. sop_flag of the M×N coding block is used to indicate whether second order prediction is performed on the M×N coding block and its m×n sub-blocks, where m≦M, n≦N, and the m×n sub-blocks belong to the current M×N coding block.

Step 32: Similarly to step 31, generate sub_sop_flag of the m×n sub-blocks according to a rule, which may be but not limited to an RDO criterion, and write sub_sop_flag of the m×n sub-blocks into a bit stream after entropy coding the sub_sop_flag of the m×n sub-blocks.

If the value of sop_flag of the M×N macroblock is 0, it indicates that second order prediction is performed on none of the m×n sub-blocks of the M×N coding block. In this case, syntax elements related to second order prediction, such as sub_sop_flag, pred_spmode_flag, and rem_sp_mode, neither need to be generated nor need to be entropy-coded and written into a bit stream.

If the value of sop_flag of the M×N coding block is 1, it indicates that second order prediction is performed for at least one m×n sub-block of the M×N coding block. In this case, the block may be divided according to the block corresponding to the first order intra-frame prediction mode of the M×N coding block. sub_sop_flag is generated for each m×n sub-block according to a rule, which may be but not limited to an RDO criterion, and written into a bit stream after being entropy coded.

For example, in the block division structure obtained according to the first order prediction mode as shown in FIG. 4, the size of the second order prediction block is 8×8. This embodiment, not limited to this block division mode, may cover other block division structures, and the size of the second order prediction block is not limited to this size. sop_flag corresponds to a block of a size of 16×16, i.e., a macroblock. However, in first order prediction mode, the 16×16 macroblock is divided into one left 8×16 block and two right 8×8 blocks. To be specific, the macroblock is divided into three sub-blocks, sub-blocks 1, 2, and 3. If the value of sop_flag is 1, sub_sop_flag used to indicate whether second order prediction is performed on all second order prediction blocks of the corresponding sub-block is generated for each of the three sub-blocks according to a rule, which may be but not limited to an RDO criterion, and sub_sop_flag of sub-blocks 1, 2, and 3 is written into a bit stream after being entropy coded.

Step 33: When the value of sub_sop_flag of a sub-block is 1, generate syntax elements such as pred_sp_mode_flag and rem_sp_mode related to second order prediction according to a rule, which may be but not limited to an RDO criterion, and write the syntax elements related to second order prediction into a bit stream after entropy coding the syntax elements related to second order prediction. For example, with regard to the 8×16 sub-block 1 as shown in FIG. 4, if the value of sub_sop_flag of the sub-block 1 is 1, a group of pred_sp_mode_flag and rem_sp_mode are generated for the sub-block 1 according to a rule, which may be but not limited to an RDO criterion, and written into a bit stream after being entropy coded. In addition, the sub-block 1 is coded by using the second order prediction technology. Reconstruction using second order prediction is performed on all second order prediction blocks of the sub-block 1 by using the same second order prediction mode rem_sp_mode. Similarly, the decoding end also uses the same rem_sp_mode to perform decoding and reconstruction using second order prediction.

When the value of sub_sop_flag of a sub-block is 0, decoding and reconstruction using second order prediction are performed for none of the second order prediction blocks of the sub-block.

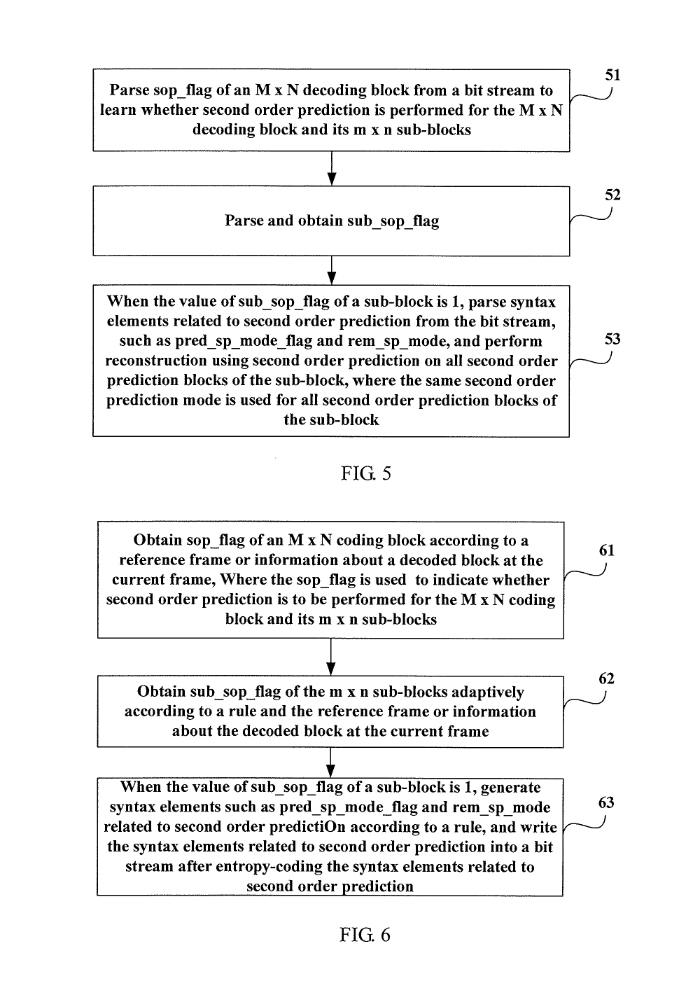

Corresponding to the third embodiment, FIG. 5 is a flowchart of a video decoding method according to a fourth embodiment of the present invention. The decoding method at the decoding end includes the following steps:

Step 51: Parse sop_flag of an M×N decoding block from a bit stream to learn whether second order prediction is performed on the M×N decoding block and its m×n sub-blocks, where m≦M, n≦N, and the m×n sub-blocks belong to the current M×N decoding block.

Step 52: Parse and obtain sub_sop_flag.

Specifically, if the value of sop_flag of the M×N decoding block is 0, it indicates that second order prediction is performed for none of the m×n sub-blocks of the M×N decoding block. In this case, sub_sop_flag and other syntax elements related to second order prediction such as pred_sp_mode_flag and rem_sp_mode do not need to be parsed from the bit stream.

If the value of sop_flag of the M×N decoding block is 1, it indicates that reconstruction using second order prediction is performed on at least one of the m×n sub-blocks of the M×N decoding block. In this case, the block may be divided according to the block corresponding to the first order intra-frame prediction mode of the M×N decoding block. sub_sop_flag is parsed from the bit stream for each m×n sub-block. For example, in a block division structure obtained according to the first order prediction mode as shown in FIG. 4, the size of the second order prediction block is 8×8. This embodiment, not limited to this block division mode, may cover other block division structures, and the size of the second order prediction block is not limited to this size. sop_flag corresponds to a block of a size of 16×16, i.e., a macroblock. However, in first order prediction mode, the 16×16 macroblock is divided into one left 8×16 block and two right 8×8 blocks. To be specific, the macroblock is divided into three sub-blocks, sub-blocks 1, 2, and 3. If the value of sop_flag is 1, sub_sop_flag is parsed from the bit stream for each of the three sub-blocks so as to indicate whether second order prediction is performed on all second order prediction blocks of the corresponding sub-block.

Step 53: When the value of sub_sop_flag of a sub-block is 1, parse syntax elements related to second order prediction from the bit stream, such as pred_sp_mode_flag and rem_sp_mode, and perform reconstruction using second order prediction on all second order prediction blocks of the sub-block. In addition, the same second order prediction mode is used for all second order prediction blocks of the sub-block. For example, with regard to the sub-block 1 of a size of 8×16 as shown in FIG. 4, if the value of sub_sop_flag of the sub-block 1 is 1, a group of pred_sp_mode_flag and rem_sp_mode of the 8×16 block are parsed from the bit stream, and decoding and reconstruction using second order prediction are performed on all second order prediction blocks and are performed in the same second order prediction mode.

When the value of sub_sop_flag of a sub-block is 0, decoding and reconstruction using second order prediction are performed for none of the second order prediction blocks of the sub-block.

FIG. 6 is a flowchart of a video coding method according to a fifth embodiment of the present invention. The method includes the following steps:

Step 61: Obtain sop_flag of an M×N coding block adaptively according to a rule, which may be but not limited to an RDO criterion, and according to a reference frame or information about a decoded block at the current frame, where the sop_flag is used to indicate whether second order predication is performed on the M×N coding block and its m×n sub-blocks, where m≦M, n≦N, and the m×n sub-blocks belong to the current M×N coding block.

Step 62: Similarly to step 61, obtain sub_sop_flag of the m×n sub-blocks adaptively according to a rule, which may be but not limited to an RDO criterion, and according to the reference frame or info/nation about the decoded block at the current frame.

If the value of sop_flag of the M×N coding block is 0, it indicates that second order prediction is performed for none of the m×n sub-blocks of the M×N coding block. In this case, sub_sop_flag and other syntax elements related to second order prediction such as pred_sp_mode_flag and rem_sp_mode do not need to be further obtained.

If sop_flag of the M×N coding block is 1, it indicates that second order prediction is performed on at least one of the m×n sub-blocks of the M×N coding block. In this case, the block may be divided according to the block corresponding to the first order intra-frame prediction mode of the M×N coding block. sub_sop_flag is obtained for each m×n sub-block adaptively according to a rule, which may be but not limited to an RDO criterion. For example, in the block division structure obtained according to the first order prediction mode as shown in FIG. 4, the size of the second order prediction block is 8×8. This embodiment, not limited to this block division mode, may cover other block division structures, and the size of the second order prediction block is not limited to this size. sop_flag corresponds to a block of a size of 16×16, i.e., a macroblock. However, in first order prediction mode, the 16×16 macroblock is divided into one left 8×16 block and two right 8×8 blocks. To be specific, the macroblock is divided into three sub-blocks, sub-blocks 1, 2, and 3. If the value of sop_flag is 1, sub_sop_flag is obtained for each of the three sub-blocks adaptively according to a rule, which may be but not limited to an RDO criterion, and according to the reference frame or information about the decoded block at the current frame, where the sop_flag is used to indicate whether second order predication is performed on all second order prediction blocks of the corresponding sub-block. The obtaining sub_sop_flag adaptively may specifically include: directly obtaining sub_sop_flag of the current sub-block according to the value of sub_sop_flag of the decoded block of the reference frame corresponding to a motion vector. The method for obtaining sub_sop_flag adaptively is not limited to the above-described method.

Step 63: When the value of sub_sop_flag of a sub-block is 1, generate syntax elements such as pred_sp_mode_flag and rem_sp_mode related to second order prediction according to a rule, which may be but not limited to an RDO criterion, and write the syntax elements related to second order prediction into a bit stream after entropy coding the syntax elements related to second order prediction.

When the value of sub_sop_flag of a sub-block is 0, decoding and reconstruction using second order prediction are performed on none of the second order prediction blocks of the sub-block. For example, with regard to the sub-block 1 of a size of 8×16 as shown in FIG. 4, if the value of sub_sop_flag of the sub-block 1 is 1, a group pf pred_sp_mode_flag and rem_sp_mode are generated for the sub-block 1 according to a rule, which may be but not limited to an RDO criterion, and written into a bit stream after being entropy coded. Second order prediction is performed on the sub-block. Second order prediction is performed on all second order prediction blocks of the sub-block 1 by using the same second order prediction mode rem_sp_mode. Similarly, the decoding end also uses the same rem_sp_mode to perform decoding and reconstruction using second order prediction.

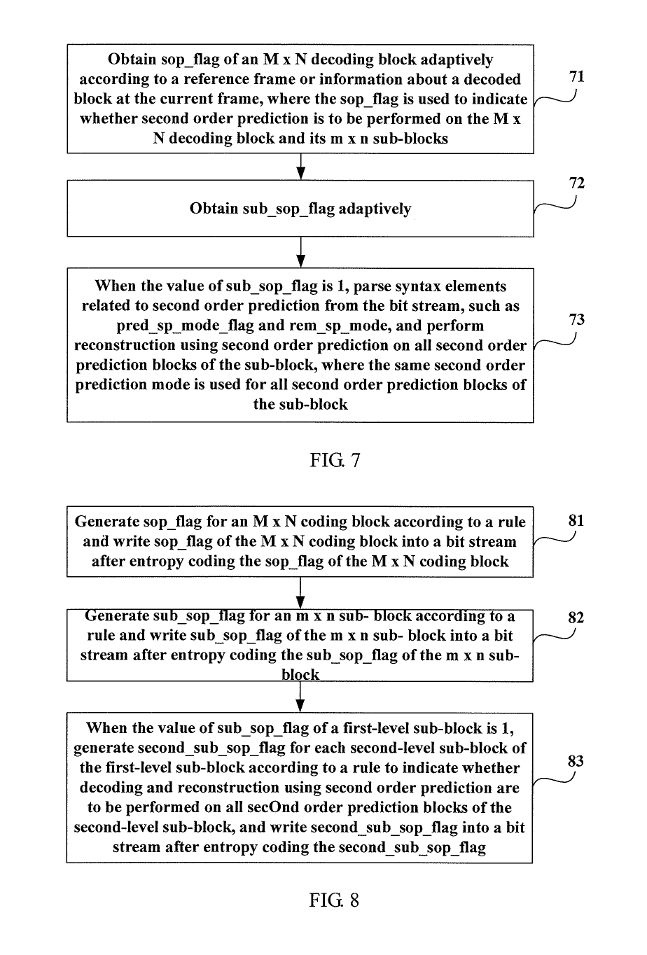

Corresponding to the fifth embodiment, FIG. 7 is a flowchart of a video decoding method according to a sixth embodiment of the present invention. The decoding method at the decoding end includes the following steps:

Step 71: Obtain sop_flag of an M×N decoding block adaptively according to a reference frame or information about a decoded block at the current frame, where the sop_flag is used to indicate whether second order prediction is performed on the M×N decoding block and its m×n sub-blocks, where m≦M, n≦N, and the m×n sub—blocks belong to the current M×N decoding block.

Step 72: Obtain sub_sop_flag adaptively.

Specifically, if the value of sop_flag of the M×N decoding block is 0, it indicates that second order prediction is performed on none of the m×n sub-blocks of the M×N decoding block. In this case, sub_sop_flag and other syntax elements related to second order prediction such as pred_sp_mode_flag and rem_sp_mode do not need to be further obtained.

If sop_flag of the M×N decoding block is 1, it indicates that second order prediction is performed on at least one of the m×n sub-blocks of the M×N decoding block. In this case, the block may be divided according to the block corresponding to the first order intra-frame prediction mode of the M×N decoding block. sub_sop_flag is obtained for each m×n sub-block adaptively according to the reference frame or information about the decoded block at the current frame. For example, in the block division structure obtained according to the first order prediction mode as shown in FIG. 4, the size of the second order prediction block is 8×8. This embodiment, not limited to this block division mode, may cover other block division structures, and the size of the second order prediction block is not limited to this size. sop_flag corresponds to a block of a size of 16×16, i.e., a macroblock. However, in first order prediction mode, the 16×16 macroblock is divided into one left 8×16 block and two right 8×8 blocks. To be specific, the macroblock is divided into three sub-blocks, sub-blocks 1, 2, and 3. If the value of sop_flag is 1, sub_sop_flag is obtained for each of the three sub-blocks adaptively according to the reference frame or information about the decoded block at the current frame, where the sop_flag is used to indicate whether second order predication is performed on all second order prediction blocks of the corresponding sub-block. The obtaining sub_sop_flag adaptively may specifically include: directly obtaining sub_sop_flag of the current sub-block according to the value of sub_sop_flag of the decoded block of the reference frame corresponding to a motion vector. The method for obtaining sub_sop_flag adaptively is not limited to the above-described method.

Step 73: When the value of sub_sop_flag of a sub-block is 1, parse syntax elements related to second order prediction from the bit stream, such as pred_sp_mode_flag and rem_sp_mode, and perform second order prediction on all second order prediction blocks of the sub-block. In addition, the same second order prediction mode is used for all second order prediction blocks of the sub-block. For example, with regard to the 8×16 sub-block 1 as shown in FIG. 4, if the value of sub_sop_flag of the sub-block 1 is 1, a group of pred_sp_mode_flag and rem_sp_mode of the 8×16 block are parsed from the bit stream, and decoding and reconstruction using second order prediction are performed on all second order prediction blocks and are performed in the same second order prediction mode.

When the value of sub_sop_flag of a sub-block is 0, decoding and reconstruction using second order prediction are performed for none of the second order prediction blocks of the sub-block.

FIG. 8 is a flowchart of a video coding method according to a seventh embodiment of the present invention. The method includes the following steps:

Step 81: Generate sop_flag for an M×N coding block according to a rule, which may be but not limited to an RDO criterion, and write sop_flag of the M×N coding block into a bit stream after entropy coding the sop_flag of the M×N coding block. sop_flag of the M×N coding block is used to indicate whether second order prediction is performed for the M×N coding block and its m×n sub-blcoks, where m≦M, n≦N, and the m×n sub-blocks belong to the current M×N coding block.

Step 82: Similarly to step 81, generate sub_sop_flag of the m×n sub-blocks according to a rule, which may be but not limited to an RDO criterion, and write sub_sop_flag of the m×n sub-blocks into a bit stream after entropy coding the sub_sop_flag of the m×n sub-blocks.

Specifically, if the value of sop_flag of the M×N coding block is 0, it indicates that second order prediction is performed on none of the m×n sub-blocks of the M×N coding block. In this case, sub_sop_flag and other syntax elements related to second order prediction such as pred_sp_mode_flag and rem_sp_mode do not need to be written into a bit stream after being entropy coded.

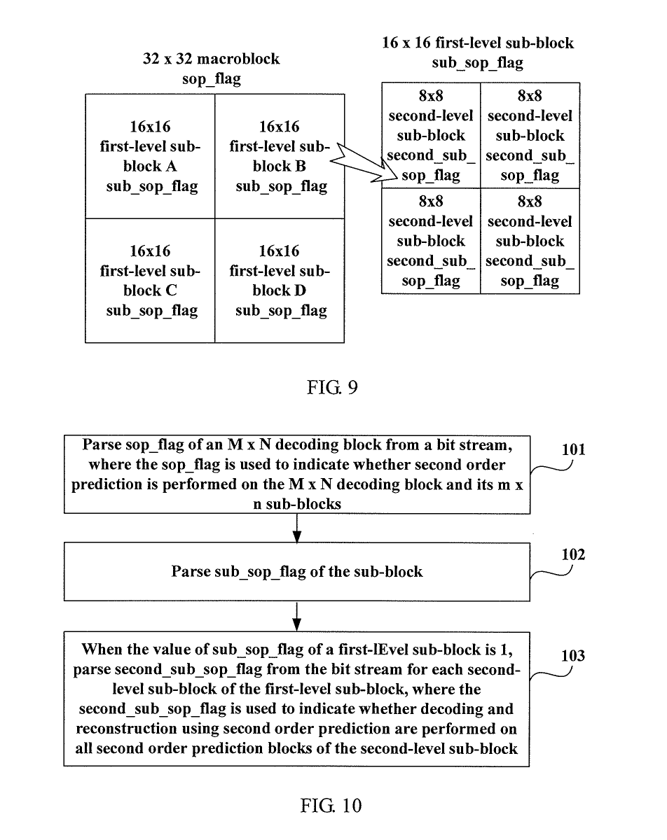

If sop_flag of the M×N coding block is 1, it indicates that second order prediction is performed on at least one of the m×n sub-blocks of the M×N coding block. In this case, the block may be divided according to the block corresponding to the first order intra-frame prediction mode of the M×N coding block. sub_sop_flag is generated for each m×n first-level sub-block according to a rule, which may be but not limited to an RDO (Rate Distortion Optimization) criterion, and written into a bit stream after being entropy coded. For example, in the block division structure obtained according to the first order prediction mode as shown in FIG. 9, the size of the second order prediction block is 8×8. This embodiment, not limited to this block division mode, covers other block division structures, and the size of the second order prediction block is not limited to this size. sop_flag corresponds to a macroblock of a size of 32×32. In first order prediction mode, the 32×32 macroblock is divided into four 16×16 first-level sub-blocks, first-level sub-blocks A, B, C, and D. Each first-level sub-block of a size of 16×16 is divided into four second-level sub-blocks of a size of 8×8. If the value of sop_flag is 1, sub_sop_flag used to indicate whether second order prediction is performed on all second order prediction blocks of the corresponding first-level sub-block is generated for each of the four first-level sub-blocks according to a rule, which may be but not limited to an RDO criterion, and sub_sop_flag is written into a bit stream after being entropy coded.

Step 83: When the value of sub_sop_flag of a first-level sub-block is 1, generate second_sub_sop_flag for each second-level sub-block of the first-level sub-block according to a rule, which may be but not limited to an RDO criterion, where the second sop_flag is used to indicate whether decoding and reconstruction using second order prediction are performed on all second order prediction blocks of the second-level sub-block, and write second_sub_sop_flag into a bit stream after entropy coding the second_sub_sop_flag.

If the value of second_sub_sop_flag of a second-level sub-block is 0, it indicates that second order prediction is performed on none of the second order prediction blocks of the second-level sub-block. In this case, sub_sop_flag and other syntax elements related to second order prediction such as pred_sp_mode_flag and rem_sp_mode do not need to be written into a bit stream after being entropy coded.

If the value of second_sub_sop_flag of a second-level sub-block is 1, it indicates that second order prediction is performed on all second order prediction blocks of the second-level sub-block, and all second order prediction blocks use the same second order prediction mode. In this case, syntax elements related to second order prediction such as pred_sp_mode_flag and rem_sp_mode are generated according to a rule, which may be but not limited to an RDO criterion, and written into a bit stream after being entropy coded.

For example, with regard to the first-level sub-block B of a size of 16×16 as shown in FIG. 9, if the value of sub_sop_flag is 1, second_sub_sop_flag is generated for each 8×8 second-level sub-block according to a rule, which may be but not limited to an RDO criterion, and written into a bit stream after being entropy coded. If the value of second_sub_sop_flag of an 8×8 second-level sub-block is 1, syntax elements related to second order prediction such as pred_sp_mode_flag and rem_sp_mode are generated according to a rule, which may be but not limited to an RDO criterion, and written into a bit stream after being entropy coded. In addition, second order prediction is performed on the second-level sub-block. Second order prediction is performed on all second order prediction blocks of the second-level sub-block using the same second order prediction mode rem_sp_mode. Similarly, the decoding end also uses the same rem_sp_mode to perform decoding and reconstruction using second order prediction.

When the value of sub_sop_flag of a first-level sub-block is 0, decoding and reconstruction using second order prediction are performed on none of the sub-blocks of the first-level sub-block.

Corresponding to the seventh embodiment, FIG. 10 is a flowchart of a video decoding method according to an eighth embodiment of the present invention. The decoding method at the decoding end includes the following steps:

Step 101: Parse sop_flag of an M×N decoding block from a bit stream, where the sop_flag is used to indicate whether second order prediction is performed on the M×N decoding block and its m×n sub-blocks, where m≦M, n≦N, and the m×n sub-blocks belong to the current M×N decoding block.

Step 102: Parse sub_sop_flag of the sub-block.

Specifically, if the value of sop_flag of the M×N decoding block is 0, it indicates that second order prediction is performed for none of the m×n sub-blocks of the M×N decoding block. In this case, sub_sop_flag and other syntax elements related to second order prediction such as pred_sp_mode_flag and rem_sp_mode do not need to be parsed from the bit stream.

If sop_flag of the M×N decoding block is 1, it indicates that second order prediction is performed for at least one of the m×n sub-blocks of the M×N decoding block. In this case, the block may be divided according to the block corresponding to the first order intra-frame prediction mode of the M×N decoding block, and sub_sop_flag is parsed from the bit stream for each m×n first-level sub-block. For example, in the block division structure obtained according to the first order prediction mode as shown in FIG. 9, the size of the second order prediction block is 8×8. This embodiment, not limited to this block division mode, covers other block division structures, and the size of the second order prediction block is not limited to this size. sop_flag corresponds to a macroblock of a size of 32×32. In first order prediction mode, the 32×32 macroblock is divided into four first-level sub-blocks of a size of 16×16, which are first-level sub-blocks A, B, C, and D. Each 16×16 first-level sub-block is divided into four 8×8 second-level sub-blocks. If the value of sop_flag is 1, sub_sop_flag is parsed from the bit stream for each of the four first-level sub-blocks to indicate whether second order prediction is performed on all second order prediction blocks of the corresponding first-level sub-block.

Step 103: When the value of sub_sop_flag of a first-level sub-block is 1, parse second_sub_sop_flag from the bit stream for each second-level sub-block of the first-level sub-block, where the second sop_flag is used to indicate whether decoding and reconstruction using second order prediction are performed on all second order prediction blocks of the second-level sub-block.

If the value of second_sub_sop_flag of a second-level sub-block is 0, it indicates that second order prediction is performed on none of the second order prediction blocks of the second-level sub-block. In this case, sub_sop_flag and other syntax elements related to second order prediction such as pred_sp_mode_flag and rem_sp_mode do not need to be parsed from the bit stream.

If the value of second_sub_sop_flag of a second-level sub-block is 1, it indicates that second order prediction is performed for all second order prediction blocks of the second-level sub-block, and all second order prediction blocks use the same second order prediction mode.

For example, with regard to the first-level sub-block A of a size of 16×16 as shown in FIG. 9, if the value of sub_sop_flag is 1, second_sub_sop_flag is parsed from the bit stream for each 8×8 second-level sub-block. If the value of second_sub_sop_flag of an 8×8 second-level sub-block is 1, a group of pred_sp_mode_flag and rem_sp_mode of the 8×8 second-level sub-block are parsed from the bit stream, and decoding and reconstruction using second order prediction are performed on all second order prediction blocks and are performed in the same second order prediction mode.

When the value of sub_sop_flag of a first-level sub-block is 0, decoding and reconstruction using second order prediction are performed on none of the sub-blocks of the first-level sub-block.

According to the first, third, fifth, seventh, and ninth embodiments, sub_sop_flag may be coded in context adaptive binary arithmetic coding (Context Adaptive Binary Arithmetic Coding, CABAC) mode to ensure that the information coding performance in second order prediction mode can still be improved when a syntax element is added.

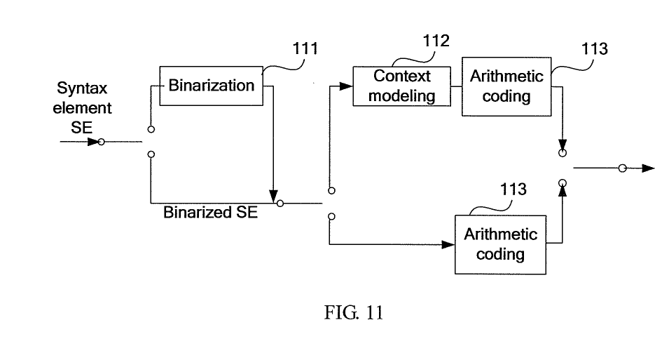

The basic coding process in CABAC mode may involve binarization, context modeling, and binary arithmetic coding. In binarization, values of each non-binary syntax element are converted into binary bit sequences. If the syntax elements are binary, this process is not necessary. In context modeling, each bit of the bit sequences of binarized syntax elements is provided with a probability model for probability prediction. In some cases, a previously coded syntax element or bit sequence may be needed. CABAC involves two coding modes, regular coding mode (regular coding mode) and bypass coding mode. The regular coding mode uses context modeling, whereas, to increase the coding speed, the bypass coding mode does not use context modeling. FIG. 11 illustrates the coding process.

Step 111: Perform binarization. To reduce the complexity of arithmetic coding and increase the coding speed, CABAC uses binary arithmetic coding rather than multi-decimal arithmetic coding. Therefore, each syntax element needs to be converted into a unique binary sequence which is referred to as a bin string (bin sting) in H.264. Meanwhile, the size of the binary sequence needs to be reduced so as to reduce the coding complexity in subsequent arithmetic coding. CABAC uses four basic binary conversion modes.

Step 112: Perform context modeling. Before arithmetic coding, context modeling must be performed. Context modeling is to establish a probability model and predict the value and probability of each bit to be coded. In H.264, 399 context models are defined, which may be classified into four types. The first type of model needs to be established according to its neighboring coded syntax element, and generally, a corresponding probability model is established by using its left and upper syntax elements to perform probability prediction for a current syntax element. The second type of model is only used for macroblocks and sub-macroblocks. The probability model for the N^{th} bit is selected by referring to the model used by the previously coded N−1 bit. The third and fourth types of models are only used for coding the residual data. These two types of models depend on the type of the coding block. The third type of model does not depend on coded data but the location of the data in a scanning path. The fourth type of model calculates the number of levels that are coded before the level of the bit. In H.264, in addition to these conditional probability models, other fixed probability models are defined, which provide fixed probability prediction for the bit to be coded and do not vary according to previously coded bits.

Step 113: Perform binary arithmetic coding. In CABAC, the value 0 or 1 of each bit to be coded is represented by the most probable symbol (most probable symbol, MPS) or the least probable symbol (least probable symbol, LPS). The MPS indicates the most probable state, corresponding to the value 0 or 1 that has a larger probability. The LPS indicates the least probable state, corresponding to the value 0 or 1 that has a smaller probability. Therefore, only one variable is needed to store the probability of the LPS. Meanwhile, the variable quantizes the probability into 64 grades, each of which is uniquely defined by its corresponding index σ. Thus, in CABAC, each context model may be uniquely determined by two variables.

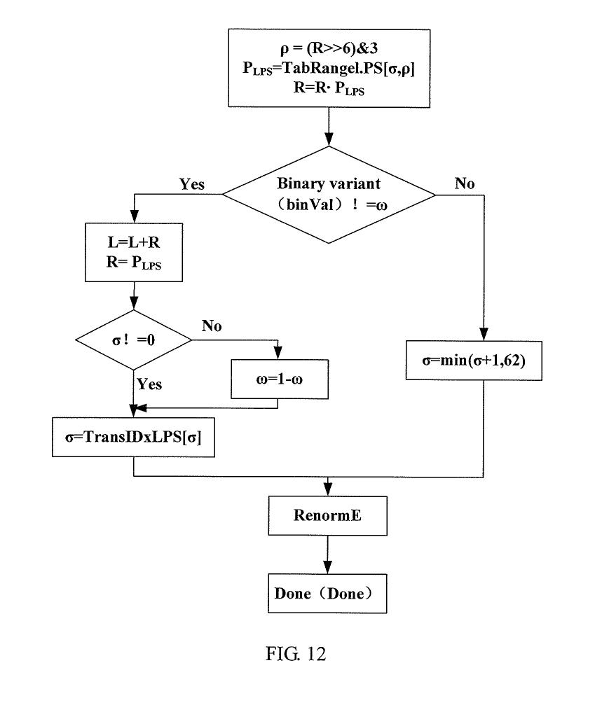

FIG. 12 illustrates a flowchart of arithmetic coding in CABAC. The probability model of CABAC effectively reduces the calculation workload during probability estimation and refreshing. In CABAC, a 4×64 two-dimensional table is first established, storing a multiplication result calculated in advance. With no doubt, input parameters in one column of the table are from Px, and input parameters in the other column of the table are from R. Px may directly use σ as a parameter, and the quantization formula of R is as follows:

ρ=(R>>6)&3

In the formula, R indicates the size of a current range, ρ indicates the result of R, >> indicates right shift of bits, and & indicates a bit-wise “AND” operation.

Each time when the multiply operation is performed, the result may be obtained by querying the table using ρ and σ. After the probability model and multiplication model are established, in a progressive calculation process, CABAC needs to save the record state of the variable, including: lower threshold L of the current range, size R of the current range, current MPS character, and probability index σ of the LPS.

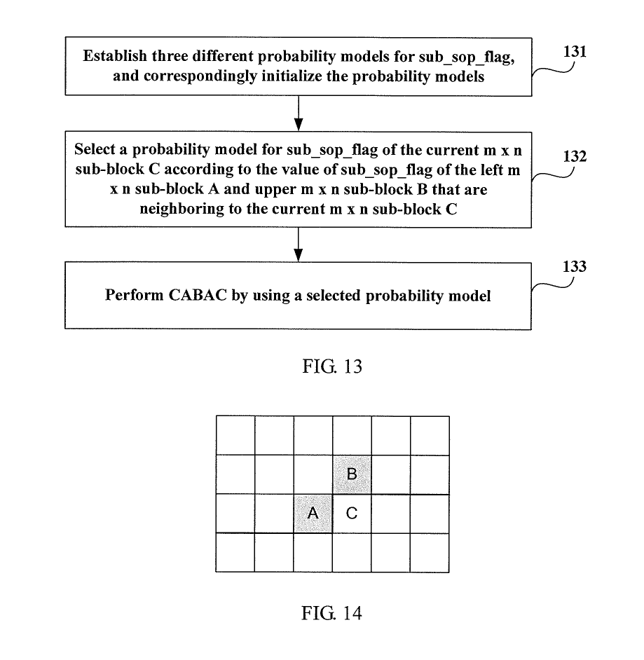

FIG. 13 is a flowchart of a coding method for syntax element sub_sop_flag of an m×n sub-block in the coding method according to an embodiment of the present invention. For example, in the sub-blocks A, B, and C as shown in FIG. 14, coding of the syntax element sub_sop_flag of the m×n sub-block includes the following steps:

Step 131: Establish three different probability models for sub_sop_flag, and correspondingly initialize the probability models. Assume that 0, 1, and 2 denote the three probability models.

Step 132: Select a probability model for sub_sop_flag of the current m×n sub-block C according to the value of sub_sop_flag of the left m×n sub-block A and upper m×n sub-block B that are neighboring to the current m×n sub-block C. The formula for selecting the probability model is as follows:

Context_{—}sub_{—}sop_flag(C)=sub_{—}sop_flag(A)+sub_{—}sop_flag(B)

Context_sub_sop_flag(C) indicates the probability model of the arithmetic coding and decoding to be used by the current m×n sub-block C. sub_sop_flag (x) indicates the value of sub_sop_flag of the m×n sub-block x. If the m×n sub-block x is unavailable, sub_sop_flag (x)=0. If the values of sub_sop_flag of the sub-blocks A and sub-blocks B are 0, the probability model 0 is selected. If the value of sub_sop_flag of the sub-block A is 0 and the value of sub_sop_flag of the sub-block B is 1, the probability model 1 is selected. If the values of sub_sop_flag of the sub-blocks A and sub-blocks B are 1, the probability model 2 is selected.

Step 133: Perform CABAC by using a selected probability model. CABAC uses high-efficiency arithmetic coding and meanwhile takes the video stream-specific statistical performance into full consideration, therefore greatly improving the coding efficiency.

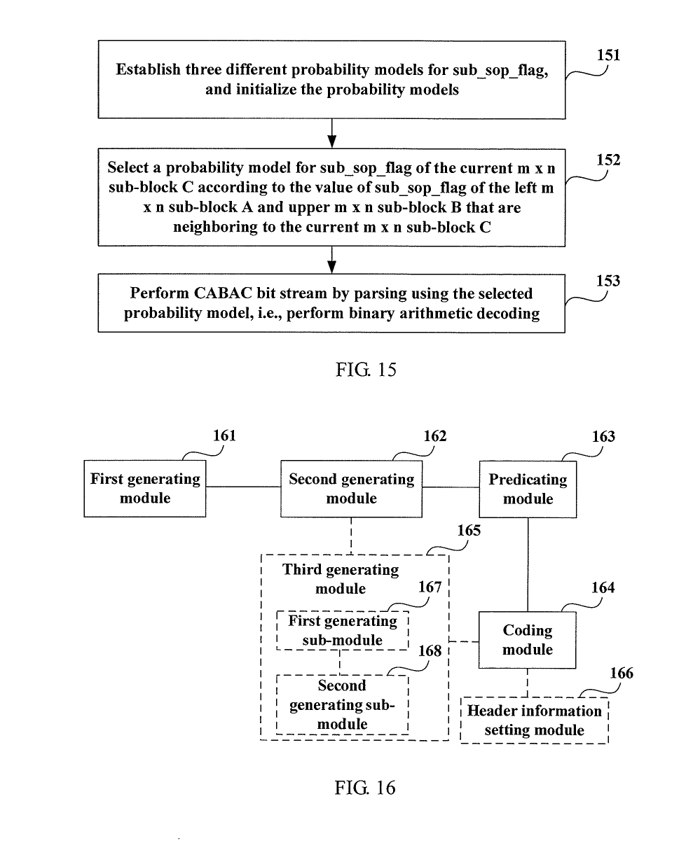

Correspondingly, FIG. 15 is a flowchart of a decoding method for syntax element sub_sop_flag of an m×n sub-block in the video decoding method according to an embodiment of the present invention. The decoding processing includes the following steps:

Step 151: Establish three different probability models for sub_sop_flag, and initialize the probability models. Assume that 0, 1, 2, and 3 denote the three probability models.

Step 152: Select a probability model for sub_sop_flag of the current m×n sub-block C according to the value of sub_sop_flag of the left m×n sub-block A and upper m×n sub-block B that are neighboring to the current m×n sub-block C. The formula for selecting the probability model is as follows:

Context_{—}sub_{—}sop_flag(C)=2×sub_{—}sop_flag(A)+sub_{—}sop_flag(B)

Context_sub_sop_flag(C) indicates the probability model of the arithmetic coding and decoding to be used by the current m×n sub-block C. sub_sop_flag(x) indicates the value of sub_sop_flag of the m×n sub-block x. If the m×n sub-block x is unavailable, sub_sop_flag(x)=0. If the values of sub_sop_flag of the sub-blocks A and sub-blocks B are 0, the probability model 0 is selected. If the value of sub_sop_flag of the sub-block A is 0 and the value of sub_sop_flag of the sub-block B is 1, or the value of sub_sop_flag of the sub-block A is 1 and the value of sub_sop_flag of the sub-block B is 0, the probability model 1 is selected. If the values of sub_sop_flag of the sub-blocks A and sub-blocks B are 1, the probability model 2 is selected.

Step 153: Perform CABAC bit stream parsing by using the selected probability model, i.e., perform binary arithmetic decoding, to obtain a binary value (bin), and directly assign the bin value to sub_sop_flag.

FIG. 16 is a schematic structural diagram of a video coding apparatus according to an embodiment of the present invention. The coding apparatus includes: a first generating module 161, a second generating module 162, a predicating module 163, and a coding module 164. The first generating module 161 is configured to generate sop_flag for a coding block. For example, the first generating module 161 obtains sop_flag of the coding block adaptively. For the details, reference can be made to the description in step 11 in the method embodiment. The second generating module 162 is configured to generate sop_flag for at least one sub-block of the coding block, i.e., sub_sop_flag, when the coding block needs second order prediction, where sub_sop_flag is used to indicate whether second order prediction is performed on the sub-block. For example, the second generating module 162 obtains sub_sop_flag of each sub-block of the coding block adaptively. For the details, reference can be made to the description in step 12 in the method embodiment. The predicating module 163 is configured to perform prediction according to sop_flag of the coding block and at least one sub_sop_flag of the coding block to obtain a prediction image. The coding module 164 is configured to obtain a prediction residual according to the prediction image, and code the prediction residual.

The video coding apparatus provided in the embodiment of the present invention may further include: a third generating module 165, configured to generate corresponding pred_sp_mode_flag for the sub-block of the coding block, on which second order prediction is performed. For the details, reference can be made to the description in the method embodiments. In this case, the coding module 164 may be further configured to perform entropy coding on pred_sp_mode_flag, and then write the coded pred_sp_mode_flag into a bit stream. When sop_flag and sub_sop_flag need to be transmitted to the decoding end, the coding module 164 is further configured to perform entropy coding on sop_flag and sub_sop_flag and then write the coded sop_flag and sub_sop_flag into a bit stream. During the entropy coding for sub_sop_flag, the coding module 164 may be specifically configured to perform CABAC.

According to the video coding apparatus in this embodiment, the unit identified by sop_flag for second order prediction is refined to the sub-block level in a way of identifying the sub-block of the coding block by using sub_sop_flag. To be specific, the size of the block on which second order prediction is performed is reduced or appropriately combined to bring advantages of the second order prediction technology into full play so that the coding efficiency when all of the sub-blocks of the current coding block do not use second order prediction is higher than that when all sub-blocks of the coding block use second order prediction, or higher than that when none of the sub-blocks of the coding block use second order prediction.

When sop_flag and sub_sop_flag do not need to be transmitted to the decoding end, the video coding apparatus provided in the embodiment of the present invention may further include a header information setting module 166. The header information setting module 166 is configured to add a syntax element used to indicate whether adaptation is used during current frame coding in slice header information of the bit stream so that the decoding end can determine according to the syntax element whether to parse sop_flag and sub_sop_flag from the bit stream or obtain sop_flag and sub_sop_flag adaptively.

When the sub-block on which second order prediction is performed is divided into multiple second-level sub-blocks, the third generating module 165 may include a first generating sub-module 167 and a second generating sub-module 168. For the details about the second-level sub-blocks, reference can be made to the description in the method embodiments.

The first generating sub-module 167 is configured to generate second sub_sop_flag for each second-level sub-block of the first-level sub-block on which second order prediction is performed, where second_sub_sop_flag is used to indicate whether second order prediction is performed on the corresponding second-level sub-block. The second generating module 168 is configured to generate corresponding pred_sp_mode_flag for the second-level sub-block on which second order prediction is performed.

In this case, the coding module 164 is further configured to perform entropy coding on second_sub_sop_flag, and then write the coded second_sub_sop_flag into the bit stream.

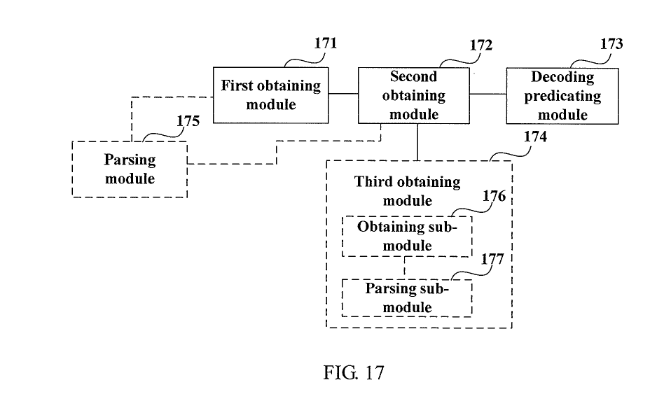

FIG. 17 is a schematic structural diagram of a video decoding apparatus according to an embodiment of the present invention. The video decoding apparatus includes: a first obtaining module 171, a second obtaining module 172, and a decoding predicating module 173. The first obtaining module 171 is configured to obtain sop_flag of a decoding block. For example, the first obtaining module 171 is specifically configured to parse sop_flag of the decoding block from a bit stream. For the details, reference can be made to the description in step 21 in the method embodiment. The second obtaining module 172 is configured to obtain sop_flag of at least one sub-block of the decoding block, i.e., sub_sop_flag, when sop_flag of the decoding block indicates that the decoding block needs second order prediction. For example, the second obtaining module 172 is specifically configured to parse sub_sop_flag of each sub-block of the decoding block from the bit stream. Specifically, the second obtaining module 172 may be configured to parse sub_sop_flag of each sub-block of the decoding block from the bit stream by using context-based adaptive binary arithmetic decoding. The sub_sop_flag is used to indicate whether second order prediction is performed on the corresponding sub-block. For the details, reference can be made to the description in step 22 in the method embodiment. The decoding predicating module 173 is configured to perform prediction according to sop_flag of the decoding block and sub_sop_flag of the at least one sub-block of the decoding block to obtain a prediction image.

The video decoding apparatus provided in the embodiment of the present invention may further include: a third obtaining module 174, configured to parse from the bit stream the corresponding pred_sp_mode_flag for the sub-block of the decoding block, on which second order prediction is performed, where the pred_sp_mode_flag is used to perform second order prediction. For the details, reference can be made to the description of the method embodiments.

The video decoding apparatus provided in the embodiment of the present invention may further include a parsing module 175, configured to parse, from slice header information of the bit stream, a syntax element used to indicate whether adaptation is used during current frame coding. When adaptation is used during the current frame coding, the first obtaining module 171 is specifically configured to obtain sop_flag of the decoding block adaptively; and the second obtaining module 172 is specifically configured to obtain each sub_sop_flag of the decoding block adaptively.

When a first-level sub-block (for the details, reference can be made to the description in the method embodiments) is divided into multiple second-level sub-blocks, the third obtaining module 174 may include: an obtaining sub-module 176 and a parsing sub-module 177. The obtaining sub-module 176 is configured to obtain second sub_sop_flag of each second-level sub-block of the first-level sub-block on which second order prediction is performed, where second_sub_sop_flag is used to indicate whether second order prediction is performed on the corresponding second-level sub-block. The parsing sub-module 177 is configured to parse from the bit stream the corresponding pred_sp_mode_flag for the second-level sub-block on which second order prediction is performed.

In this embodiment, the video decoding apparatus using second order prediction refines the unit for second order prediction to the sub-block by obtaining sub_sop_flag identifying the first-level sub-block of the decoding block. To be specific, the size of the block on which second order prediction is performed is reduced or appropriately combined to bring advantages of the second order prediction technology into full play so that the objects of second order prediction are more diversified, meeting the requirements for different coding efficiencies.

According to the technical solution in this embodiment, the unit identified by the second order prediction flag for second order prediction is refined to the sub-block level, i.e., the unit of the coding block identified by the second order prediction flag for second order prediction is refined, which may enhance the flexibility of second order prediction and improve the coding and decoding efficiency.

Persons skilled in the art may understand that all or part of steps according to the method embodiments may be implemented by a program instructing relevant hardware. The program may be stored in a computer readable storage medium. When the program is executed, the steps of the method in the embodiments are executed. The storage medium may be any medium that can store program codes, such as a ROM, a RAM, a magnetic disk, a CD-ROM.

Finally, it should be noted that the above embodiments are intended to describe the technical solution of the present invention only. The technical solution of the present invention is not limited thereto. Although the present invention is described in detail by referring to the exemplary embodiments, persons skilled in the art should understand that various modifications to the technical solution disclosed in the above embodiments or equivalent replacements for some technical features contained therein may be made according to the embodiments of the present invention. Such modifications and equivalent replacements fall into the principle and protection scope of the present invention.

What is claimed is:

1. A video coding method, comprising:
generating a second order prediction flag for a coding block;
when the coding block needs second order prediction, generating a second order prediction flag for at least one sub-block of the coding block, wherein the second order prediction flag of the sub-block is configured to indicate whether second order prediction is performed on the sub-block;
performing prediction according to the second order prediction flag of the coding block and the second order prediction flag of the at least one sub-block of the coding block to obtain a prediction image; and
obtaining a prediction residual according to the prediction image, and coding the prediction residual.

2. The video coding method according to claim 1, further comprising:
generating, for the sub-block of the coding block, on which second order prediction is performed, a corresponding prediction second prediction mode flag, which is used to perform second order prediction.

3. The video coding method according to claim 1, further comprising:
performing entropy coding on the second order prediction flag of the coding block and the second order prediction flag of the sub-block, writing coded flags into a bit stream, and sending the bit stream to a decoding end.

4. A video decoding method, comprising:
obtaining a second order prediction flag of a decoding block;
obtaining a second order prediction flag of at least one sub-block of the decoding block when the second order prediction flag of the decoding block indicates that the decoding block needs second order prediction; and
performing prediction according to the second order prediction flag of the decoding block and the second order prediction flag of the at least one sub-block of the decoding block to obtain a prediction image.

5. The video decoding method according to claim 4, further comprising: for the sub-block of the decoding block, on which second order prediction is performed, parsing a corresponding prediction second prediction mode flag from a bit stream, which is used to perform second order prediction.

6. The video decoding method according to claim 4, further comprising: parsing, from slice header information of a bit stream, a syntax element which is used to indicate whether adaptation is used during current frame coding.

7. The video decoding method according to claim 6, wherein:
the obtaining the second order prediction flag of the decoding block comprises: when adaptation is used during current frame coding, obtaining the second order prediction flag of the decoding block adaptively.

8. The video decoding method according to claim 6, wherein:
the obtaining the second order prediction flag of the at least one sub-block of the decoding block comprises: when adaptation is used during current frame coding, obtaining the second order prediction flag of each sub-block of the decoding block adaptively.

9. A video coding apparatus, comprising:
a first generating module, configured to generate a second order prediction flag for a coding block;
a second generating module, configured to generate a second order prediction flag for at least one sub-block of the coding block when the coding block needs second order prediction, wherein the second order prediction flag of the sub-block is used to indicate whether second order prediction is performed on the sub-block; and
a predicating module, configured to perform prediction according to the second order prediction flag of the coding block and the second order prediction flag of the at least one sub-block of the coding block to obtain a prediction image.

10. The video coding apparatus according to claim 9, further comprising:
a coding module, configured to obtain a prediction residual according to the prediction image, and code the prediction residual.

11. The video coding apparatus according to claim 9, further comprising:
a third generating module, configured to generate, for the sub-block of the coding block, on which second order prediction is performed, a corresponding prediction second prediction mode flag which is used to perform second order prediction.

12. The video coding apparatus according to claim 10, wherein:
the coding module is further configured to perform entropy coding on the second order prediction flag of the coding block and the second order prediction flag of the sub-block, and write coded flags into a bit stream.

13. The video coding apparatus according to claim 9, wherein:
the first generating module is specifically configured to obtain the second order prediction flag of the coding block adaptively.

14. The video coding apparatus according to claim 9, wherein:
the second generating module is specifically configured to obtain the second order predication flag of the sub-block for the at least one sub-block of the coding block adaptively.

15. The video coding apparatus according to claim 13, further comprising:
a header information setting module, configured to add a syntax element, which is used to indicate whether adaptation is used during current frame coding, in slice header information of a bit stream obtained by the coding module.

16. A video decoding apparatus, comprising:
a first obtaining module, configured to obtain a second order prediction flag of a decoding block;
a second obtaining module, configured to obtain a second order prediction flag of at least one sub-block of the decoding block when the second order prediction flag of the decoding block indicates that the decoding block needs second order prediction; and
a decoding predicating module, configured to perform prediction according to the second order prediction flag of the decoding block and the second order prediction flag of the at least one sub-block of the decoding block to obtain a prediction image.

17. The video decoding apparatus according to claim 16, further comprising:
a third obtaining module, configured to, for the sub-block of the decoding block, on which second order predication is performed, parse from a bit stream a corresponding prediction second prediction mode flag which is used to perform second order prediction.

18. The video decoding apparatus according to claim 16, further comprising:
a parsing module, configured to parse a syntax element, which is used to indicate whether adaptation is used during current frame coding, from slice header information of a bit stream.

19. The video decoding apparatus according to claim 18, wherein:
the first obtaining module is specifically configured to obtain the second order prediction flag of the decoding block adaptively.

20. The video decoding apparatus according to claim 18, wherein:
the second obtaining module is specifically configured to obtain the second order prediction flag of each sub-block of the decoding block adaptively.
